(19) United States
(12) Patent Application Publication
(10) Pub. No.: US 2007/0269287 A1
(43) Pub. Date: Nov. 22, 2007

(54) Wood and Plastic Screw

(76) Inventors: Erich Runge, Kuenzelsau (DE); Ralf Loeffler, Doerzbach (DE)

Correspondence Address: CARLSON, GASKEY & OLDS, P.C., 400 WEST MAPLE ROAD, SUITE 350, BIRMINGHAM, MI, 48009, US

(21) Appl. No.: 11/659,939

(22) PCT Filed: Apr. 21, 2006
(86) PCT No.: PCT/EP06/03710

§ 371 Date: Feb. 8, 2007

(30) Foreign Application Priority Data
Apr. 22, 2005 (DE) 20 2005 06 493.9

(51) Int. Cl. F16B 35/00

(52) U.S. Cl. 411/378

(57) ABSTRACT

A wood and plastic screw has an essentially cylindrical shank, a tip, and a thread extending along the shank as far as into a tip region. The thread comprises a tip-side and a head-side flank, with a head-side flank angle being larger than a tip-side flank angle. The tip-side flank angle remains approximately constant in a shank region and in the tip region whereas the head-side flank angle in the tip region is larger than that in the shank region.

### RELATED APPLICATIONS

The application is a U.S. national phase application of PCT/EP2006/003710, which was filed on Apr. 21, 2006, claiming priority to German Patent Application 20 2005 06 493.9, which was filed on Apr. 4, 2005.

### BACKGROUND OF THE INVENTION

The invention relates to a wood and plastic screw.

Wood screws, which also include chipboard screws, are intended for being screwed into a work piece as easily and quickly as possible while still having a high extraction resistance. Plastic screws are screwed into dowels and are intended to provide a high pressing in of the dowel, and thus for a high extraction resistance of the dowel.

A screw in which a screw thread in a region of the screw tip, in comparison with a shank region, has a less asymmetrical to symmetrical shape, is known from document EP 0 504 782 B1. This screw is to be distinguished by a low screwing resistance, a large stripping torque and good extraction values.

The invention provides a wood and plastic screw which can also be screwed easily in wood and in dowels and which has good extraction values. Furthermore, the manufacture of the screw according to the invention is relatively simple.

### SUMMARY OF THE INVENTION

According to the invention, this is obtained by a wood or plastic screw that has a head, an essentially cylindrical shank, a tip, and a thread extending along the shank as far as into a tip region. The thread comprises a tip-side and a head-side flank, where a head-side flank angle is larger than a tip-side flank angle. The tip-side flank angle remains approximately constant in a shank region and in the tip region whereas the head-side flank angle in the tip region is larger than that in the shank region. A flank angle is an angle enclosed by a corresponding flank with a radial plane to a center axis of the screw. In comparison with document EP 0 504 782 B1, the invention uses a different approach in which the screw thread in the tip region is in fact more asymmetrical than in the shank region. Furthermore, the manufacture is relatively simple since the tip-side flank angle remains constant in approximately the entire threaded region. However, the head-side flank angle in the tip region becomes larger than that in a flank region, i.e. there is more room in the tip region for material displaced during the manufacture of the screw, which renders the manufacture less complex to keep the required tolerances. During the screwing in of a dowel, the flank geometry provides for an increased displacement and thus for improved extraction values.

Test results have indicated that the head-side flank angle in the tip region should be larger than that in the shank region by the factor of at least 1.4.

According to one example, the head-side flank angle is approximately 40° in the tip region and approximately 25° in the shank region, the tip-side flank angle being 15°.

When manufacturing screws, the flank angles cannot be produced to an exact angular degree and it is also not possible to produce a flank angle that is uniform along the entire thread length. This is why in this context, the angle values have to be read automatically with a tolerance of ±3 degrees. The specification that an angle remains approximately constant means that it is allowed to vary within the range of ±3 degrees.

In a portion near the head, the thread should taper to the outside with a sharp edge in order to keep the screwing resistance low. In a portion of the thread near the tip, a tapering with a less sharp edge or an obtuse tapering of the flanks provides for a less strong cutting into the dowel, resulting in better pressing and higher extraction values.

Milling ribs between the thread and the head prevent a jamming of the screw shank when the screw is screwed into wood.

According to one example, the milling ribs are arranged in a shank region which has a larger outside diameter than the shank region provided with the thread. The two shank regions adjoin each other via a shoulder.

Furthermore, the wood and plastic screw according to the invention has very good screwing properties if the screw has a certain ratio between the thread pitch and the thread core diameter in the shank region. This ratio should be within the range of from 1.3 to 1.5, preferably of from 1.3 to 1.45.

Further characteristics and advantages of the invention will become apparent from the following description and the following drawing to which reference is made.

### BRIEF DESCRIPTION OF THE DRAWINGS

FIG. 1 shows an enlarged view of a wood and plastic screw according to the invention with two enlarged detailed views of thread in a region of a shank and in a region of a tip.

### DETAILED DESCRIPTION OF THE PREFERRED EMBODIMENT

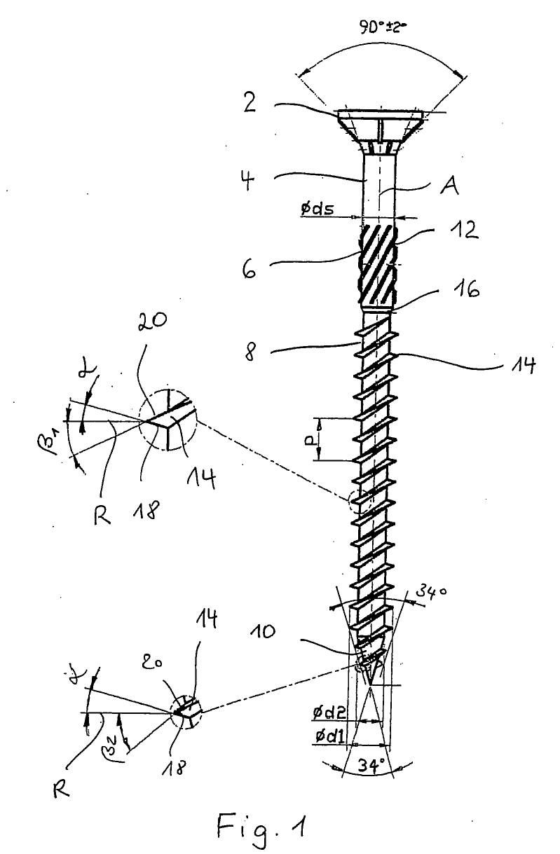

The screw shown in FIG. 1 for screwing in solid wood, chipboards, dowels etc. is made of metal and has a head 2, a shank which is to be divided up essentially in three regions 4, 6 and 8, and a tip region 10. The region 4 of the shank is configured cylindrically and has neither a thread nor other projections. The adjoining shank region 6 is provided with milling ribs 12. Regions 4 and 6 of the shank have the same diameter dₛ, (in the region 6, this diameter dₛ, is a core diameter). A two-start thread 14, which has a pitch p and extends as far as into the tip region 10, has a starting point in the region 8. Here, the core diameter d₂ is smaller than the diameter dₛ such that the regions 8 and 6 are separated from each other by a shoulder 16.

The thread 14 has a tip-side lower flank 18 and a head-side upper flank 20. A tip-side flank angle α in the region 8 of the shank is approximately as large as that in the tip region 10, and is approximately 15°. The tip-side flank angle α is measured with respect to a radial plane R, i.e. a plane which is perpendicular to a center axis or longitudinal axis A of the screw.

A head-side flank angle varies along a longitudinal extension of the thread. In the region 8 of the shank, a head-side flank angle β₁ is approximately 25°. The head-side flank angle varies as from the conically tapering tip region 10. In the tip region 10, the head-side flank angle β₂ is approximately 40° and is thus larger than in the other shank region by a factor of at least 1.4.

As already explained, the thread 14 is a two-start thread. Both flights of the thread 14 extend nearly up to the tip region 10 of the screw and start, seen in an axial direction and considering usual manufacturing tolerances, approximately at the same axial height. This can be seen in FIG. 1 in which the left lower enlarged view shows, for example, the beginning of the first thread, the second thread beginning on an opposite side and with an offset of 180° at the same axial height. The two-start thread, which projects as far as into the tip, leads to a quick and good bite of the screw in wood and in the dowel, and leads to a quick screwing of the screw. The two-start thread extends up to a head-side thread end.

A further important property of the screw represented is the run-out of the flank with different sharp edges. In a region of the thread portion near the head 2, which corresponds approximately to the upper two thirds to three quarters of the thread, the flanks 18, 20 taper to the outside with a sharp edge. In the lower third or quarter, i.e. in the portion of the thread near the tip, the tip-side lower and head-side upper flanks 18, 20 taper with a less sharp edge and preferably even slightly obtusely, which has not necessarily something to do with the flank angle itself but with the configuration of the thread. The flank tip, which may even act as a rounded or broken flank tip, provides for a reduced cutting of the threads in the dowel, for a better pressing of the dowel, and for higher extraction values. The larger head-side flank angle β₂ in the region of the tip further supports this.

Furthermore, a tip angle, which has a value of 34° in FIG. 1, is also noteworthy. The represented tip angle of 34° is related to the core diameter of the thread in the region of the tip. In the screw represented, the tip angle however remains constant if the tangent lines are applied to the head-side thread end (cf. upper angle of 34° in FIG. 1).

The ratio of the thread pitch p to the thread core diameter d₂ (d₁, is the head diameter) in the region 8 of the shank should be within a range of from 1.3 to 1.5 in order to obtain an excellent extraction resistance for a low screwing torque.

What is claimed is:

1. A wood and plastic screw comprising:
an essentially cylindrical shank;
a tip; and
a thread extending along the essentially cylindrical shank as far as into a tip region, the thread comprising a tip-side flank and a head-side flank, with a head-side flank angle being larger than a tip-side flank angle, and the tip-side flank angle remaining approximately constant in a shank region and in the tip region whereas the head-side flank angle in the tip region is larger than that in the shank region.

2. The wood and plastic screw according to claim 1, wherein in the tip region, the head-side flank angle is larger than in the shank region by the factor of at least 1.4.

3. The wood and plastic screw according to claim 1, wherein the head-side flank angle in the tip region is approximately 40°.

4. The wood and plastic screw according to claim 1, wherein the head-side flank angle in the shank region is approximately 25°.

5. The wood and plastic screw according to claim 1, wherein in a portion near a head, the thread tapers to the outside with a sharp edge.

6. The wood and plastic screw according to claim 5, wherein a portion near the tip, the thread tapers obtusely or with a less sharp edge than in a portion near the head.

7. The wood and plastic screw according to claim 5, including a shank region formed with milling ribs that is provided between the thread and the head.

8. The wood and plastic screw according to claim 7, wherein the shank region having the milling ribs adjoins the shank region having the thread via a shoulder.

9. The wood and plastic screw according to claim 1, wherein the thread is a two-start thread in which both flights project as far as into the tip region and start in the tip region approximately at the same height with respect to an axial direction.

10. The wood screw according to claim 1, wherein a ratio of thread pitch to thread core diameter in the shank region is in a range of 1.3 to 1.5.
